(19) United States
(12) Patent Application Publication
(10) Pub. No.: US 2004/0103140 A1
(43) Pub. Date: May 27, 2004

(54) Method and device for providing access to remotely stored data

(75) Inventors: Wyatt Allen Huddleston, Philomath, OR (US); Diana Irene Resendez, Streamwood, IL (US); Kevin Robert Kuphal, Lake in the Hills, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/284,904

(22) Filed: Oct. 31, 2002

(51) Int. Cl. G06F 15/16; G06F 17/60

(52) U.S. Cl. 709/203; 705/26; 709/219

(57) ABSTRACT

A computer network or server (14) provides or enables a data output or printing service for a user of a subscriber device (12). The user stores a document in a user account at a memory source (309) of the server (14) via a computer (20) that has a network connection to a network (18) and thus server. The user later accesses the user account via the subscriber device (12) and requests that the data be sent to a retrieval zone corresponding to the subscriber device. The server with the subscriber unit determines a particular output device of a plurality of output devices (16). The server (14) forwards the data to the particular output device where the data is provided to the user in, for example, a printed document.

### BACKGROUND OF THE INVENTION

1. Field of the Invention

The present invention relates generally to communications systems and more specifically to methods and devices that allow for or provide access to remotely stored data within such systems.

2. Description of the Related Art

Printing services, for example, are conventionally obtained by hand delivering documents or a storage medium containing the documents to a commercial printing service provider. However, obtaining printing services in the conventional manner requires an individual to personally carry hard copies of the information or a storage medium containing the confidential information. In these situations, theft or loss of this confidential information can possibly lead to negative consequences. Also, hard copies of these documents may be so numerous that it would be cost prohibitive to ship them.

Additional situations may require access to documents that are outside of an individual's immediate possession. If this individual is not near or does not have ready access to a computer connected to the Internet, it can be very difficult to obtain access to the documents. Therefore, a need exists for methods and devices that allow or provide for access to documents stored remotely from the user.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages all in accordance with the present invention.

FIG. 1 depicts, in a simplified and representative form, an exemplary environment in which wireless access to electronically stored documents is provided.

FIG. 2 depicts a block diagram of a preferred embodiment of a subscriber device with computer network access capability.

FIG. 3 depicts a block diagram of a preferred embodiment of a server for storing and providing access to stored documents.

FIG. 4 and FIG. 5 illustrate a flow chart of a preferred method embodiment of providing wireless access to electronically stored documents.

### BRIEF DESCRIPTION OF THE PREFERRED EMBODIMENTS

In overview form, the present disclosure concerns communications systems that provide or allow access to data and data hosts from remotely located users. The present disclosure further concerns subscribers or users, preferably wireless devices that have the capability of making a wireless connection to the Internet. Note that subscriber device or unit may be used interchangeably herein with wireless device or unit and each of these terms denotes a device ordinarily associated with a user and typically a wireless device that may be used with a public network in accordance with a service agreement or within a private network.

As further discussed below various inventive principles and combinations thereof are advantageously employed to provide a user of a subscriber device with wireless access to data stored electronically and remotely at a host on the network, thus alleviating various risks and inconveniences associated with personally carrying confidential electronic data as well as the embarrassment and other problems associated with forgetting a file or otherwise needing a file that is not immediately available.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions or integrated circuits (ICs) such as application specific ICs or combinations of both. It is expected that one of ordinary skill, notwithstanding possibly significant effort and many design choices motivated by, for example, available time, current technology, and economic considerations, when guided by the concepts and principles disclosed herein will be readily capable of generating such software instructions and programs or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

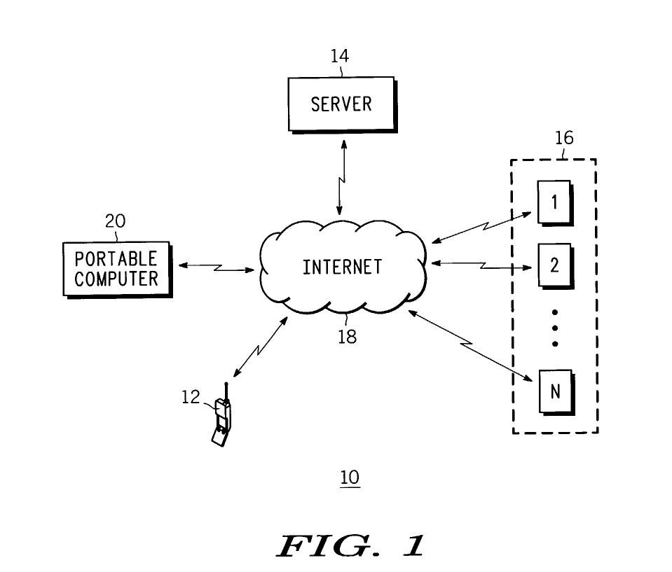

Referring now to the drawings in which like numerals reference like parts, FIG. 1 shows an exemplary environment 10 in which a service for providing wireless access to remotely and electronically stored documents (service) is implemented. The environment 10 includes a wireless subscriber device (subscriber device) 12, a computer network or remote host or server 14 (server), a plurality of commercial data output service providers that each provide an output device 16 such as, for example, a printer, a projector, a CD or other media writer, or a plotter, etc. In addition a personal computer such as a portable computer 20 is depicted. All of the aforementioned elements or devices are capable of supporting a network connection with, for example, the Internet, public switched telephone network or other wide area network represented generally by 18. Generally files, documents, or data is forwarded from the personal computer 20 and stored on the server 14. At some later time and from a remote location the subscriber device 12 is provided access to the server and assisted by the server in determining a suitable output device, such as a commercial printer or the like where the files or documents may be accessed or provided. The subscriber device 12, the server or host 14 and the plurality of output devices 16 will be discussed more fully below.

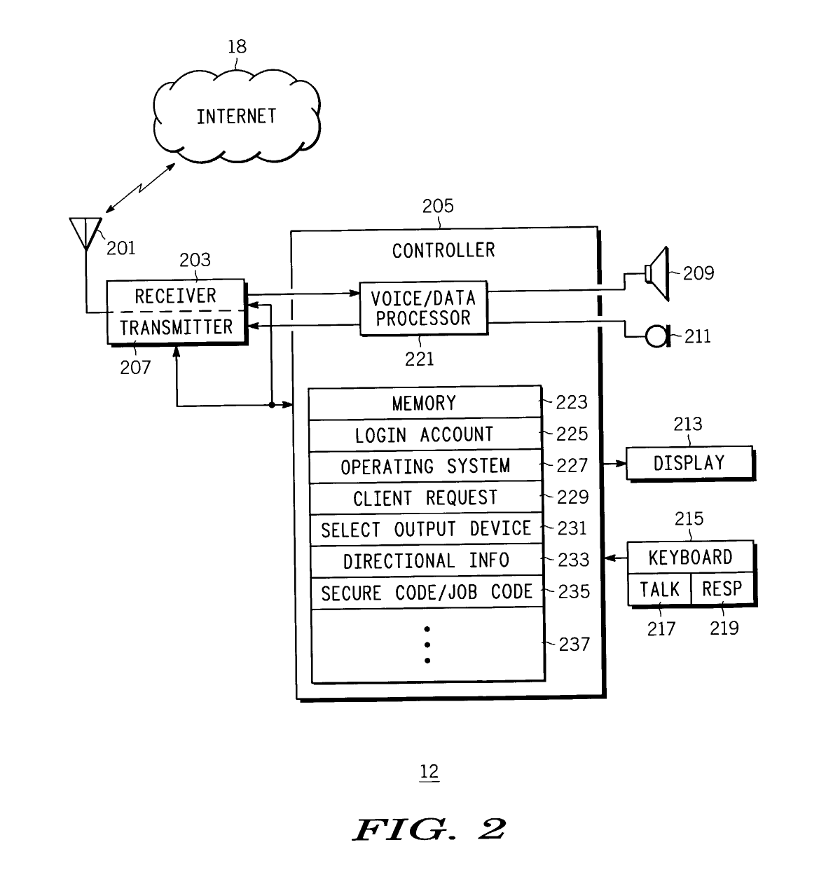

The subscriber device 12 may be, for example, a mobile telephone or portable handset, a personal digital assistant, a messenging device, or the like such as a cellular handset widely available from numerous manufacturers, provided the subscriber device has appropriate wireless access to network 18. In fact the portable computer could be the subscriber device. Handsets such as General Packet Radio Service (GPRS) or 3G phones with always on data services would be suitable platforms. Referring to FIG. 2, a block diagram of a preferred embodiment of the subscriber device 12 will be discussed and described. The subscriber device 12 is arranged and constructed for among others, sending a client request, preferably via a wireless connection to the network 18 and thus the computer network or host or server 14 and for receiving identification information regarding one or more of the plurality of output devices 16 via, for example, a network connection to the Internet or network 18. Note that the client request may be, for example, a session initiation protocol or wireless access protocol message or a text message or voice message originated at or by the subscriber device 12.

The subscriber device 12 includes an antenna 201 that operates to absorb and radiate radio frequency signals that are received by a receiver (or receiving device) 203 or transmitted or sent from or by a transmitter (or transmitting device) 207 of the subscriber device 12 as is known. The subscriber device has or supports a network connection with the network 18 via a service provider or the like (not shown) as also is known. The receiver and transmitter 203, 207 are inter coupled as depicted and interactively operate with and are controlled by a controller 205 to provide to, or accept or receive from the controller 205, voice traffic or data messages or signals corresponding thereto as is also known. The controller 205 is coupled to and operates in a known manner together with a speaker or earpiece 209, a microphone 211, a display 213 and a keyboard 215 or set of keys including a talk key 217 and a respond key 219 to effect a user interface. The keyboard can be a known physical keyboard or virtual keyboard that is part of the display 213. The display 213 is a conventional display such as a liquid crystal display or the like. If the keys are part of a virtual keyboard, the display 213 will need to be touch sensitive or the like in order to convey information to the controller 205. Similarly the speaker or earpiece, microphone, and alerting device are known and widely available.

The controller 205 is essentially a general-purpose processor and, preferably, includes a voice and data processor 221 and an associated memory source 223. The voice and data processor 221 is, preferably, a known processor based element with functionality that will depend on the specifics of the air interface with the radio access network as well as various network protocols for voice and data traffic. The processor 221 will operate to encode and decode voice and data messages to provide signals suitable for a transducer or further processing by the controller 205. The processor 221 may include one or more microprocessors, digital signal processors, and other integrated circuits depending on the responsibilities of the controller with respect to signal processing duties that are not here relevant. In any event, the controller 205 also includes the memory source 223 that may be a combination of known RAM, ROM, EEPROM or magnetic memory.

The memory source 223 is used to store among various other items or programs etc., a login account routine (optional) 225 for permitting a user to obtain secure access to a user account at the host or server 14, an operating system 227, a client request generation routine 229 for generating a client request and optionally receiving a confirmation of data availability, an output device selection routine 231 for accepting a selection indication of a particular output device by a user and generating a selection signal corresponding to the selection indication, a direction information routine 233 for receiving directional information regarding a particular data output unit of the one or more data output units such as directions to the particular output device, and a secure code and job code display routine 235 for displaying a secure code received from the particular output device for providing secure access to the particular data. The operating system 227 and the abovementioned routines are machine readable code or software instructions that when executed by the controller or processor included therewith will result in the controller 205 performing the requisite functions of the subscriber device 12 such as interfacing with the receiver 203 and transmitter 207, speaker 209, microphone 211, display 213, keyboard 215 and so on including various other routines 237 that are too numerous to mention but that will be evident to one of ordinary skill given a specific subscriber device, etc. The reader will appreciate that this listing is merely a brief listing of exemplary routines that will be required or advantageous in effecting a client request and a selection of an output device and that other optional applications may be stored in the memory that have not been mentioned.

The transmitter 207 is arranged and controlled by the controller to send signals, such as, for example, a signal corresponding to a login request, client request or selected output device to the computer network 14 via a network connection to the Internet or network 18 and thus host or server 14. The controller 205 is coupled to the transmitter and operates in accordance with one or more of the login account routine 225, client request generation routine 229 and output device selection routine 231 within the memory source 223, to forwards the appropriate signals to the transmitter 207. The client request may include, for example, a request for access to particular data such as a document, a specified retrieval zone such as a zip code, form values for customizing the particular data and/or a specified security level. The login request may include, for example, a specific user name and password. The selected output device may be, for example, a specific commercial printing service provider or overhead projector or the like. The user inputs, initiates or selects the client request, selected output device or login request via, for example, the keyboard 215 or by speaking into the microphone 211. An indication thereof is generated by the controller, specifically associated processors executing the above routines in accordance with the operating system 227.

The receiver 203 is arranged to receive signals such as, for example, a signal corresponding to identification information regarding one or more output devices in a specified retrieval zone, a confirmation that particular data at a particular output device is available, directional information to an output device, and/or a secure code or job code for obtaining data at the output device. The controller 205, which is coupled to the receiver 203 and operates in accordance with the output device selection routine 231, direction information routine 233, and the secure code and job code display routine 235, generates either a text display corresponding to the received signal via, for example, the display 213 or a voice message corresponding to the received signal via, for example, the speaker 209 in response to a received signal. The information displayed or voiced by virtue of the controller 205 includes a list of identification information regarding one or more output devices corresponding to a retrieval zone (generated by the output device selection routine 231), a confirmation message that the particular data requested in the client request is available at the particular output device of the one or more output devices, and a job code and/or secure code received from the particular output device (the secure code is received if a higher level of security was specified in the client request). It should be noted that in a preferred embodiment the subscriber device 12 does not receive the data stored remotely at the host or server 14.

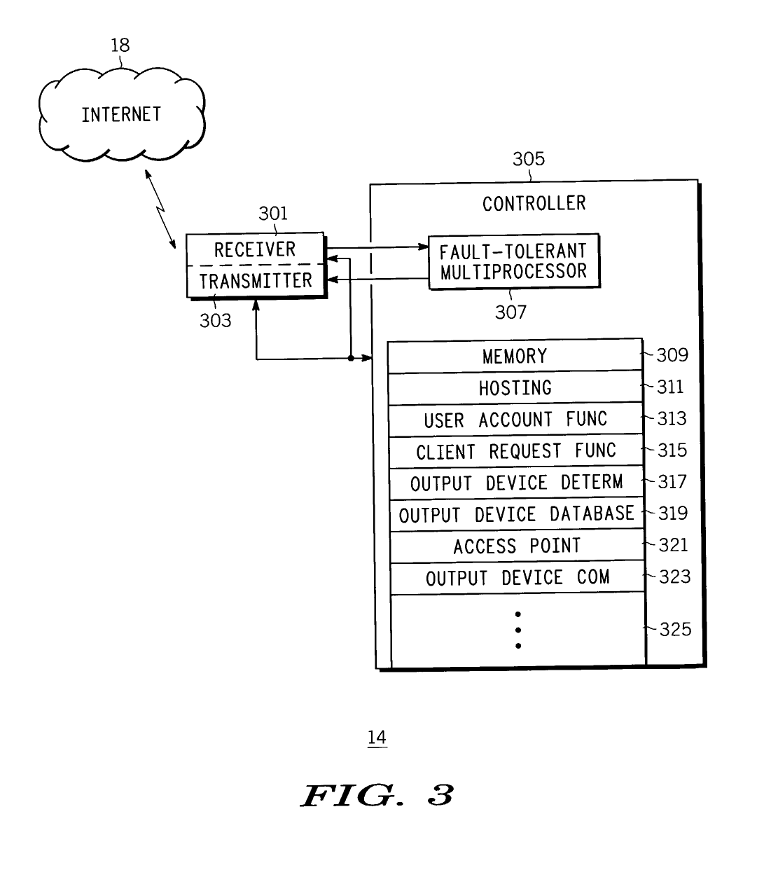

Referring to FIG. 3, a block diagram of a preferred embodiment of a host or network server 14 will be discussed and described. The server 14 is arranged and constructed for among others, serving as a remote host for a plurality of user accounts and storing electronic data therein for user access. The server may be a solitary server or part of a server farm with a plurality of servers that may be referred to as a computer network. The server 14 includes a receiver 301 and a transmitter 303 having a network connection to the Internet 18. The receiver 301 and the transmitter 303 may be implemented as a conventional modem or Ethernet transceiver as is known. The receiver and transmitter 301, 303 are inter coupled as depicted and interactively operate with and are controlled by a controller 305 to provide to, or accept or receive from the controller 305, data messages or signals corresponding thereto as is also known. The controller 305 is essentially a general-purpose processor and, preferably, includes a fault tolerant multi-processor 307 and a memory source 309. The fault tolerant multi-processor 309 may include one or more microprocessors, digital signal processors, and other integrated circuits depending on the responsibilities and configuration of the server that are not here relevant. Another form of processor as appreciated by those skilled in the art may replace the fault tolerant multi-processor 307. In any event the controller 305 also includes the memory source 309 that may be a combination of known RAM, ROM, EEPROM or magnetic memory suitable for mass storage.

The memory source 309 is used to store among various other items or programs etc., a hosting program 311 for providing a plurality of users with access to and storage of data, a user account routine 313 for permitting secure access to a user account, a client request routine 315 for processing a client request received by a user, an output device determination routine 317 for determining if an output devices satisfies parameters specified in the client request, an output device database 319 for storing identification information and other parameters for each of a plurality of output devices 16, access point instructions 321 for providing an access point for users to store data in a user account, and an output device communication routine 323 for sending data to a particular output device and exchanging user data. The memory source 309 includes various other routines 325 that are too numerous to mention but that will be evident to one of ordinary skill given a specific server, etc. The reader will appreciate that this listing is merely a brief listing of exemplary routines that will be required or advantageous in effecting a host and that other optional applications may be stored in the memory that have not been mentioned.

The hosting program 311 is for permitting the host or server 14 to serve as a host for a plurality of user accounts and for associating data stored in the memory source 309 with a particular user account for later access. The hosting program 311 provides a plurality of user accounts and associated data stored in the memory source 309. A user account may be accessed by, for example, receiving a specific user name and password. The hosting program also likely maintains a charge or billing record for each account for usage thereof.

The access point instructions 321 are for providing an access point to permit remote user access to a user account via the network 18 with the server 14. The access point may be, for example, a website, a file transfer protocol (ftp) site, email addresses, facsimile reception device, or the like. The hosting program 311 permits the server 14 to communicate this access point over the Internet 18. The access point instructions or the like 321 in conjunction with the user account routine 313 permit a user to store data such as documents in their user account in the memory source 309. For example, the user may access a user account by, for example, accessing the website and logging into a user account while using a personal computer 20. From there, the client can upload data to their user account in the memory source 309 (provided by the user account routine) from the personal computer 20. The data stored in the memory source 309 is associated with the user account for permitting easy retrieval by the client. The computer network 14 may also includes instructions for authenticating access to user accounts via the website, ftp site or the like by, for example, conventional user name and password methods.

The client request routine 315 is for processing a client request that is received from a remote subscriber device 12 by the receiver 301. More specifically, when the receiver 301 receives a signal corresponding to a client request, the controller 305, operating in accordance with the client request routine 315, determines the parameters that are specified in the client request. These parameters are passed to the output device determination routine 317. Then, the controller 305, operating in accordance with the output device determination routine 317, commands the processor 307 to search through the output device database 319 to determines if there are one or more existing output devices that meet the parameters, such as location or retrieval zone or perhaps device code as specified in the client request. For example, if the client request included a specified retrieval zone such as a zip code and a form value, the processor 307 would search through the output device database 319 and determine if there are one or more existing output devices that include the specified zip code and are compatible with or capable of handling the specified form value capability as part of their identifying information. Instructions may optionally be included for sending an availability inquiry to the one or more output devices that were determined to meet the parameters in order to ensure that they are available. The controller 305, operating in accordance with the client request routine 315, then generates a list of the available output devices for sending to the subscriber device 12 of the user by the transmitter 303. The list will include information corresponding to the existing output devices such as, for example, the name, address, and hours of operation of the output device. If there are no output devices 16 available within the specified retrieval zone, the client request routine 315 may include instructions for sending an advisory message to the subscriber device 12 informing the user to alter the specified retrieval zone. The client request routine 315 also processes a signal corresponding to a selected output device. For example, when the receiver 203 receives the signal corresponding to a selected output device of the one or more output devices, the processor 307, operating in accordance with the client request routine 315, obtains directional information for the selected particular output device by, for example, querying a website. This directional information or directions for traveling to the output device is transmitted to the subscriber device 12.

The output device communication routine 14 further includes instructions for sending the data, along with any specific output instructions, such as printing, plotting, display, or configuration instructions specified by the subscriber device 12 in the client request or output device selection message or information, to the particular selected output device that was selected by the user at the subscriber device 12 and for processing data received from the particular selected output device such as, for example, a job code and/or a secure code, or an unavailability reply. The job code and/or secure code, or unavailability reply is sent to the user of the subscriber device 12.

Referring back to the output devices 16 of FIG. 1, each of the output devices 16 is, preferably associated with or provided by a commercial data output service provider that has partnered or formed an association with the server 14. Partnering may refer to, for example, a commercial data output service provider that has agreed to provide address information to the server 14 and accept users thereof. Each of the output devices 16 may be, for example, a printer, or the like as noted above, and has a software application 26 for communicating with the computer network 14 via a network connection to the Internet 18. The software application 26 of the output devices 16 includes instructions for receiving particular data and specific data processing parameters, such as, for example, form values and a secure code, from the server 14, instructions for printing the particular data in accordance with the associated instructions, and perhaps instructions for sending the server 14 billing parameters for printing or otherwise providing the particular data. The software application 26 of the output devices 16 may also include instructions for printing the particular data only after authenticating a user by requesting verification data that corresponds to the secure code and printing the particular data only subsequent to receiving the verification data. The software application may also include instructions for receiving an availability inquiry from the remote member host 14.

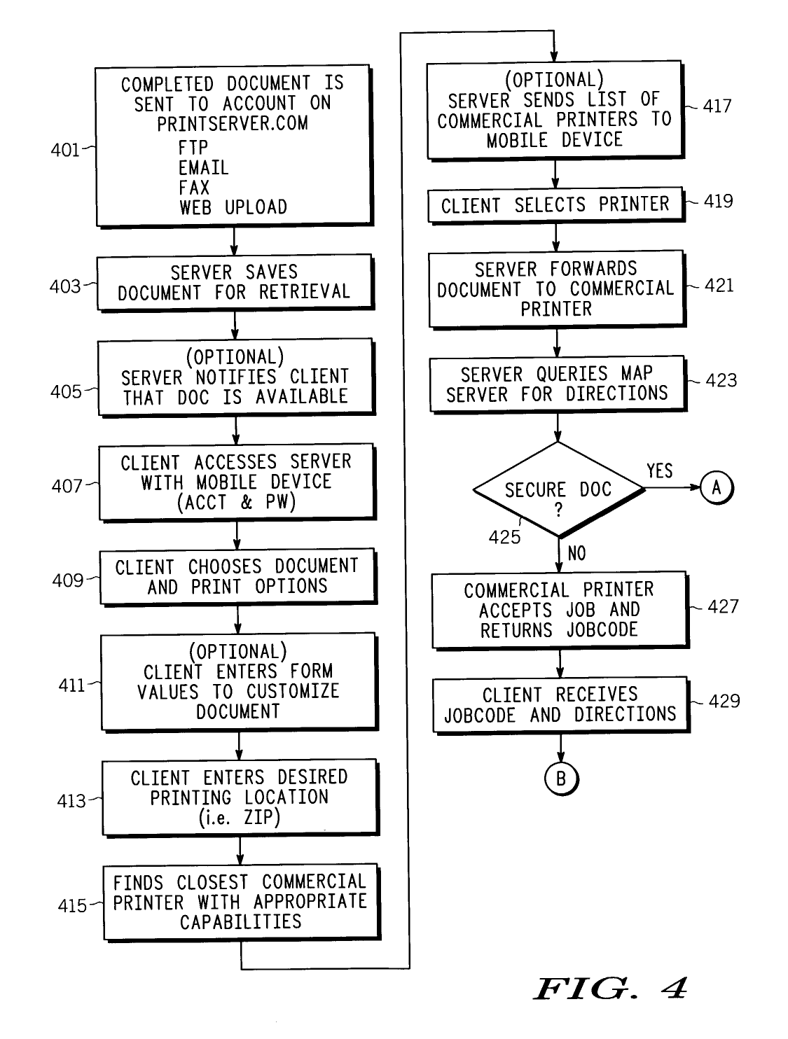

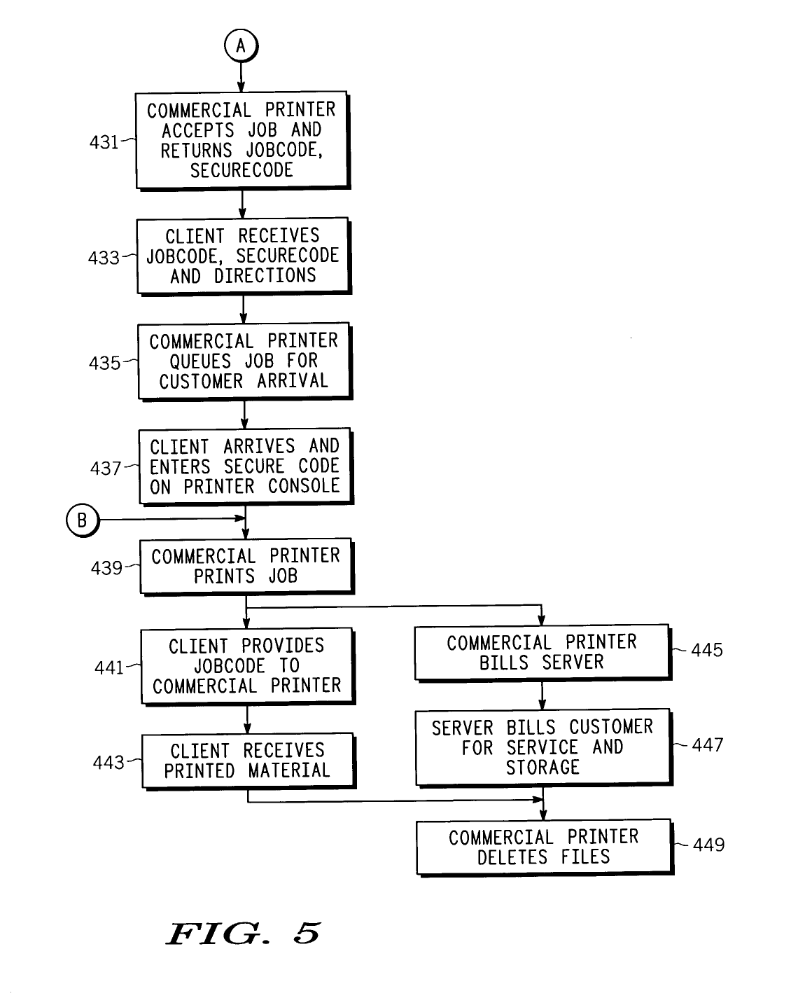

Referring to FIG. 4 and FIG. 5, a methodology for implementing the service will now be discussed in view of the elements illustrated in FIGS. 1-3. At 401, a user sends data to a user account at the computer network 14 via, for example, a personal computer 20 that has a network connection to the Internet 18. This is done by, for example, sending the data via an ftp connection to the computer network 14, emailing the data to the computer network 14, faxing the data to the computer network 14, or uploading the data to the computer network 14 via a website. The data sent to the computer network 14 may be, for example, a completed text document. At 403, the computer network 14 receives this data via the network connection, associates the data with the user account and stores the data in the memory source 24 for future retrieval. Optionally, at 405 the computer network 14 can notify the user that the data was successfully saved and is available for retrieval. This can be done by, for example, sending a text message to the subscriber device 12 of the user via the network connection to the Internet 18.

At 407, the user accesses the user account at the computer network 14 by, for example, entering a user name and password via the keyboard 215 of the subscriber device 12 and transmitting it to the computer network 14 via the network connection to the Internet or network 18. The user is then logged into the user account by the user account routine 313 of the server 14. At 409, the user sends a client request from the subscriber device 12 to the server 14. The client request includes a request for access to particular data. The client request may also include print options, such as, for example, a classification of the particular data as secure or non-secure. Optionally, at 411 the user may specify additional parameters such as form values for customizing the particular data. For example, if the data being requested is a document, the additional parameters may be two-sided or one-sided copies, formatting parameters and the like. At 413, the user specifies a retrieval zone for the document. The retrieval zone may be, for example, a city, zip code or specific output device or simply the location for the subscriber device such as would be available from a GPS receiver included with the device. The subscriber device may enter other indicia of location that can be understood by the server or used by the server. For example entering an airport code, such as DFW, may be used to direct the subscriber device to a suitable location. Specifying the retrieval zone may optionally be done at 409 along with the client request that included the request for access to particular data.

At 415, the server 14 determines if there are available output devices such as printers in the specified retrieval zone or the nearest output device, and if the available output devices have the capabilities to output or print the data as specified by the user. More specifically, the server 14 searches through the output device database 319 stored in the memory source 309 of identifying information for each of the plurality of output devices 16 to find particular output devices having the specified capabilities within the specified retrieval zone. These particular output devices may optionally be sent an availability inquiry to determine if they are presently available. At 417, the server 14 sends a list of the particular output devices or locations such as gate 24 if an airport code had been provided, to the subscriber device 12 or the user. At 419, the client then selects one of the particular output devices and sends the selection to the server 14.

At 421, the computer network or server 14 forwards an output job, for example, a print job to the particular output device selected by the user via the network connection to the Internet 18. The print job includes the particular data, print instructions and any additional parameters specified by the client. At 423, the server 14 queries a map database to obtain directional information for the particular output device. This directional information is stored for later forwarding to the subscriber device 12 of the client. The map database may be, for example, a website.

At 425, it is determined whether the data requested by the user is or is expected to be secure data. This can be done by, for example, reviewing the print options of the client request or file properties. If the data is determined to not be secure data, then at 427 the particular output device accepts the print job and forwards a job code to the server 14. The server 14 receives the job code and forwards it to the subscriber device 12 along with the directional information of the particular output device. The forwarding is done via network connections, preferably, to the Internet 18. At 429, the user or subscriber device receives the job code and directional information and the method moves via B to FIG. 5.

If the data is determined to be secure data at 425, then (following A to FIG. 5) at 431 the particular output device accepts the print job and forwards the job code and a secure code to the server 14. The server 14 receives the job code and secure code, and forwards them along with the directional information of the particular output device to the subscriber device 12 of the client. At 433, the user receives the job code, secure code and directional information. At 435, the particular output device queues the print job for customer arrival. At 437, the client arrives at the particular output device, and enters the secure code on, for example, a printer console.

The particular output device may optionally forward the job code and secure code directly to the subscriber device 12 rather than to the server 14. This can be done by forwarding network connection information for the subscriber device 12, such as, for example, a subscriber device Internet protocol address, to the particular output device along with the print job at 50. The output device then contacts the subscriber device and so on.

At 439, the particular output device prints the print job in accordance with the additional parameters specified by the client. At 441, the user provides the particular output device with the job code, and at 443 the user receives the printed materials from the particular output device.

At 445, after printing the job the particular output device or printer bills the server 14 for the print job. At 447, the server 14 subsequently bills the user for the service and also for storing the data in the memory source 309. At 449, the particular output device or printer deletes the job code and the process ends.

Therefore, the present invention provides a service for providing wireless access to and outputting data via for example printing of the data. The user sends the data via, for example, a personal computer 20 with a network connection to the server 14, which stores the data in the memory source 309. As a result, the user does not have to personally carry the data. When the user would like to output or print particular data, the client requests the particular data and a specified retrieval zone by sending a client request from a subscriber device 12 to the server 14. The user is subsequently given directions to the print service provider, when required, and a secure code if a higher level of security is specified. The user is then able to obtain the printed copies of the data from the commercial print service provider. As a result, the user is able to obtain printed copies of a document by a simple request on a subscriber device 12, which eliminates the need to obtain access to a computer connected to the Internet 18.

While the above description is of the preferred embodiment of the present invention, it should be appreciated that the invention may be modified, altered, or varied without deviating from the scope and fair meaning of the following claims. For example, the server 14 may utilize the subscriber device current location as a basis for determining a retrieval zone rather than receiving a specific retrieval zone from the subscriber device 12. In addition, the server 14 may bid the print job out to output devices within the specific retrieval zone and give the print job to a lowest bidder.

What is claimed is:

1. A method for providing a subscriber device with access to data stored at a computer network, the method comprising:
receiving a client request from the subscriber device, the client request including a request for access to the data;
determining if there are one or more output devices in a retrieval zone corresponding to the subscriber device; and
sending the data to a particular output device of the one or more output devices in the retrieval zone.

2. The method of claim 1, wherein the determining if there are one or more output devices in a retrieval zone corresponding to the subscriber device further comprises determining if there are existing output devices within the retrieval zone by searching through a database of output device information and sending information corresponding to the existing output devices to the subscriber device.

3. The method of claim 1, wherein the receiving a client request from the subscriber device further comprises receiving the client request further including one of the retrieval zone and a form value for customizing the data.

4. The method of claim 1, further comprising sending location information corresponding to the particular output device to the subscriber device.

5. The method of claim 1, wherein the sending the data to a particular output device of the one or more output devices in the retrieval zone further comprises sending the data to the particular output device selected by the subscriber device.

6. The method of claim 1, further comprising receiving one or more data files that include the data via a network connection and storing the data in a memory source.

7. The method of claim 6, wherein the receiving one or more data files that include the data via a network connection and storing the data in a memory source further comprises storing the one or more data files in the memory source as data associated with a user account.

8. A method for wirelessly accessing data stored electronically comprising:
sending a client request to a server via a wireless connection, the client request including a request for access to data;
receiving, via the wireless connection, identification information regarding one or more output devices that correspond to a retrieval zone; and
selecting, via the wireless connection, a particular output device of the one or more output devices.

9. The method of claim 8, wherein the sending a client request to a server via a wireless connection further comprises sending the client request further including one of the retrieval zone and form values for customizing the particular data.

10. The method of claim 8, further comprising receiving, via the wireless connection, a secure code from the particular output device for providing secure access to the data.

11. The method of claim 8, further comprising obtaining secure access to a user account at the server as part of the sending a client request to a server via a wireless connection.

12. A subscriber device arranged and constructed to access data stored electronically at a computer network comprising:
a transmitting device for sending a request to the computer network via a network connection, wherein the request includes a request for access to data; and
a receiving device for receiving identification information regarding one or more data output units for the data,
wherein the transmitting device and the receiving device do not receive the data.

13. The subscriber device of claim 12, further comprising a selecting device for selecting a particular data output unit of the one or more data output units via the network connection.

14. The subscriber device of claim 12, wherein the request further includes a retrieval zone.

15. The subscriber device of claim 12, wherein the receiving device is further for receiving identification information regarding the one or more data output units in a specified retrieval zone.

16. The subscriber device of claim 12, wherein the client request further includes a form value for customizing the data.

17. The subscriber device of claim 12, wherein the receiving device is further for receiving a secure code from the one of the one or more data output units for providing secure access to the data.

18. A software program arranged to provide wireless access to data stored electronically at a computer network, the software program when installed and executing on a subscriber device processor resulting in the subscriber device:
generating a client request for the computer network, the client request including a request for access to particular data;
displaying identification information regarding one or more output devices corresponding to a retrieval zone; and
displaying a confirmation received via a network connection that the particular data is available at a particular output device of the one or more output devices.

19. The software program of claim 18, further comprising:
accepting a selecting indication from a user of the subscriber device; and
generating a selection signal corresponding to the selection indication.

20. The software program of claim 18, further comprising generating the client request to further include the retrieval zone and form values for customizing the particular data.

21. The software interface of claim 18, further comprising displaying a secure code received from the particular output device for providing secure access to the particular data.
